(19) United States
(12) Patent Application Publication
(10) Pub. No.: US 2010/0148559 A1
(43) Pub. Date: Jun. 17, 2010

(54) HEAD RESTRAINT FOR A SEAT, IN PARTICULAR A VEHICLE SEAT

(76) Inventors: Carsten Prokop, Duisburg (DE); Hüseyin Tüblüker, Heiligenhaus (DE); Daniel Overdick, Dusseldorf (DE)

Correspondence Address: Alix Yale & Ristas, 750 Main Street, Hartford, CT, 05103, US

(21) Appl. No.: 12/733,240

(22) PCT Filed: Aug. 19, 2008
(86) PCT No.: PCT/EP2008/006791

§ 371 Date: Feb. 19, 2010

(30) Foreign Application Priority Data
Aug. 22, 2007 (DE) 102007039659.9

(51) Int. Cl. B60N 2/48; A47C 7/36; A47C 7/38; A47C 31/00; G02B 7/182

(52) U.S. Cl. 297/391

(57) ABSTRACT

A headrest (1) for a seat (2), in particular a vehicle seat, having at least two signal electrodes (4) for detecting the position of a head of a person (P) sitting on the vehicle seat by producing capacitors each with a counter-electrode formed by the person's (P) head, and the at least two signal electrodes (4) are connected to evaluation electronics (5), the signal electrodes (4) being assigned a compensation device (6) which is connected to the evaluation electronics (5) and, with a rear region of the headrest (1), produces a compensation capacitor device.

The invention relates to a headrest for a seat, in particular a vehicle seat, according to the precharacterizing clause of claim 1.

DE 199 16 804 C1 discloses an apparatus for adjusting a vehicle headrest in relation to the position of a passenger's head, said apparatus having a sensor which is arranged in the headrest and is intended to detect the position of a head. The sensor contains two capacitor plates which are arranged above one another and are part of a capacitor in which the passenger's head acts as a dielectric. Since there are people with more or less pronounced backs of the head or with necks of greater or lesser thickness, it is not possible to adjust the headrest in this manner.

WO 2006/094784 A1 discloses a backrest for a vehicle seat, in which the height of a headrest can be adjusted with respect to the backrest. A sensor for detecting the position of the head of a person sitting on the vehicle seat relative to the headrest and for indicating an adjusted end position is arranged in the headrest. At least two sensors in the form of capacitive proximity sensors are arranged in the headrest. The position of the headrest in relation to the head is indicated on the basis of the recorded capacitances which are situated, as a capacitance, on the electrodes formed by the head and one of the at least two proximity sensors.

The at least two proximity sensors described in WO 2006/094784 A1 record any change in the charge in the electrodes which is not based on the presence of the head as a further electrode. For example, metal and/or electronic elements in the region of the headrest, that is to say a metal frame in the headrest, motors in the headrest, screens for back-seat passengers which are arranged on the headrest etc., may contribute to changing the charge on the electrodes, as a result of which it is no longer possible to correctly adjust the headrest in relation to the head.

Therefore, the object of the invention is to provide a headrest for a seat, in particular a vehicle seat, according to the precharacterizing clause of claim 1, which headrest enables improved adjustment.

This object is achieved by means of the features of claim 1.

As a result, a headrest for a seat, in particular a vehicle seat, which has at least two signal electrodes is provided. The signal electrodes are designed to detect the position of a head of a person sitting on the vehicle seat by producing capacitors each with a counter-electrode formed by the person's head. The signal electrodes are connected to evaluation electronics. The signal electrodes are assigned a compensation device which, with a rear region of the headrest, that is to say a region facing away from the head, produces a compensation capacitor device. A signal can be generated by evaluation electronics connected to the signal electrodes on the basis of the respective amount of charge on the signal electrodes and can be used to adjust the position and attitude of the headrest in relation to the head, that is to say the height and distance of the headrest in relation to the head. The compensation capacitor device forms a capacitor with the rear environment. As a result of the fact that the compensation device is connected to the evaluation electronics, environmental influences with regard to a change in the charge in the at least two signal electrodes can be taken into account. It is possible to take into account interfering influences as a result of metal parts in the region of the headrest. Interfering influences from electronic components in and/or on the headrest can likewise be taken into account. The compensation device acts both as a sensor and as a shield for the signal electrodes in that region of the headrest which is directed toward the rear, that is to say facing away from the head. Metal parts inside the headrest as well as motors inside the headrest, metal frame parts of the body and electronic devices fastened to the headrest, for example monitors, lead to a change in the charge on the signal electrodes and on the compensation capacitor produced by the compensation device, the cause of which can be detected as such and cannot be attributed to an “incorrect position” of the headrest in relation to the head. The compensation device which is directed toward the rear makes it possible to detect changes in the charge on the basis of charges other than those caused by the head. It is possible to adjust the headrest in such a manner that the height and distance of the headrest are adjusted in an optimum manner for a person sitting on the vehicle seat on the basis of the charges recorded on the electrodes.

As explained above, the headrest according to the invention makes it possible to detect the position of the head of a person sitting on the seat, and a signal from the evaluation electronics can be used to adjust the attitude of the headrest in relation to the head of the person sitting on the seat. Further signals which can be used for further applications or modules can be generated by the evaluation electronics. A signal from the evaluation electronics indicating that the headrest is adjusted to a head allows the conclusion to be drawn that a person is sitting on the seat, for example. If, in contrast, a position of a head is not detected, it is highly likely that the seat is unoccupied or is occupied by a minor or a child seat.

As additional information or further signals from the evaluation electronics, it is conceivable for an indication of the size of the person to be present in a(n) (additional) signal from the evaluation electronics. As further additional information, there may be a signal from the evaluation electronics indicating how far away the person's head is from the headrest, that is to say whether the person has rested his head against the headrest or the head is bent forward. The signal and the further signals which can be generated by the evaluation electronics can be used, for example, to adjust at least one outside mirror.

If a signal from the evaluation electronics is used as information relating to seat occupancy, the seat occupancy information determined by the headrest according to the invention can be used in addition to a seat occupancy detection apparatus, or else it is possible to dispense with an additional seat occupancy detection apparatus which is in the form of a seat mat, for example, and is usually used to obtain safety-relevant information. Seat occupancy detection apparatuses are used, for example, to determine whether or not airbags may be triggered in the case of danger. Together with the detected position of the head, it is possible to define how quickly a corresponding airbag should be triggered. In the case of the large possible number of different airbags (for example head airbag, front airbag and side airbag) in a motor vehicle, it is possible to define a sequence with different triggering times, for example. The person sitting on the seat can be classified in terms of his size and the information can be used to trigger the airbags. Provision may also be made for a seat occupancy detection apparatus, in conjunction with a seat belt as a restraint system, to provide a warning signal if a person sitting on a seat has not fastened his seat belt. A visual and/or audible signal may be generated if the seat occupancy detection apparatus provides a signal for a person on the seat and the sensor in the belt buckle simultaneously provides a signal for an engaged end piece of the seat belt. Provision may also be made for devices which are not relevant to safety to obtain the information relating to seat occupancy from a seat occupancy detection apparatus.

The headrest according to the invention makes it possible to render a seat occupancy detection apparatus superfluous and to save costs; circuits and wiring for such an apparatus also do not need to be additionally provided. However, the headrest according to the invention can also be used in addition to an existing seat occupancy detection apparatus in order to safeguard the information obtained from the individual sensors.

In principle, the headrest according to the invention can be used for any seat in which adjustment of the headrest is advantageous. The vehicle seat of a motor vehicle is such a possible use since optimum adjustment of the headrest in relation to the head of a person sitting on the vehicle seat considerably reduces the consequences of an accident if the vehicle hits an obstacle. It is also conceivable for the headrest to be used in a dentist's chair in order to reach an optimum position, which is necessary in this case to treat the person, with regard to strain relief when holding the head and for access by the dentist.

One of the at least two signal electrodes is preferably assigned one compensation electrode belonging to the compensation device, with the result that a plurality of compensation capacitor devices, namely in the number of signal electrodes, are provided. The spatial resolution with regard to induced charges is thus. increased.

The signal electrode essentially measures the charge induced “from the front”, that is to say by the head, and the compensation electrode measures the charge induced “from the rear” approximately at the same height. Production of the signal and compensation electrodes is simplified if they have the same shape and size.

The compensation electrodes are preferably arranged and designed in such a manner that they shield the respective associated signal electrode from the region facing away from the head, with the result that the compensation electrode is used both as a sensor and as a shielding electrode. The distance between the signal electrode and the compensation electrode is preferably selected to be short for this purpose. The short distance also results in the fact that a possible temperature change affects both the signal electrode and the compensation electrode. It is therefore possible to dispense with taking the temperature into account for the individual electrodes. It may also be preferred for the signal electrode to be spatially shielded to the rear from the compensation electrode assigned to it by geometrically spatially concealing the signal electrode to the rear from the compensation electrode assigned to it over an angular range of between approximately +150° and approximately −150°, in particular preferably between approximately +130° and approximately −130°, more preferably between approximately +110° and approximately −110°.

The distance and the attitude of the signal electrodes with respect to the compensation electrodes are preferably fixed in order to be able to carry out a simple comparison of the charges on both electrodes. If the attitude and the distance are known and cannot be changed, comparisons can be carried out without additionally taking into account displacements of the two electrodes with respect to one another.

It is preferably possible to change the thickness of the headrest in one dimension in the direction of the head of a person sitting on the seat. For this purpose, the headrest can have two outer parts or shells which can be moved relative to one another and can be used to change the thickness of the headrest in the direction of the head of a person sitting on the vehicle seat. The two outer parts which can be moved relative to one another in the direction of the head make it possible for the headrest to be brought closer to the head without changing the position and attitude of the backrest of the vehicle seat. The position and attitude of the backrest can be adjusted independently of the position and attitude of the headrest, that is to say the height and distance with respect to the head.

The evaluation electronics connected to the signal electrodes and compensation electrodes evaluate the charges on the individual electrodes and preferably output the result to a display for displaying the position of the headrest in relation to the head. In this case, it is possible to display whether the headrest has been positioned or adjusted such that it is too high, too low or correct, for example. This enables simple positioning in which the person sitting on the vehicle seat is informed of the adjustment of the headrest.

It may also be preferred for the evaluation electronics to be connected to a controller for controlling at least one drive in order to reach the adjusted end position of the headrest. As a result, the headrest is automatically adjusted into the optimum position such that the person sitting on the vehicle seat himself does not need to adjust the headrest.

The at least two signal electrodes are preferably designed in such a manner that, when combined, they form a field pattern which corresponds to a head section of a person sitting on the vehicle seat. It is thus possible to optimally adjust the headrest on the basis of a field pattern which is averaged over a large number of head sections of different people and is predefined by the shape and attitude of the signal electrodes and the charges stored for the signal electrodes in the evaluation electronics as a comparison. The attitude of signal electrodes of a predefined shape and the charge in the signal electrodes when the headrest is correctly positioned or adjusted can be determined on the basis of tests, with the result that the evaluation electronics indicate the position of the headrest in relation to the head on the basis of the charge in the individual signal electrodes taking into account the charge in the compensation electrodes. Any shape of signal electrode is possible in this case; particular charges on signal electrodes and compensation electrodes result with optimum positioning of the headrest if the attitude and position of the at least two signal electrodes with respect to one another are predefined.

A controller is preferably provided for at least one drive, which controller compares the amounts of charges or charges in the signal electrodes and compensation electrodes, recorded by the evaluation electronics, as actual variables with a respective predefinable desired variable of the amount of charge or charge for an adjusted end position. The drive is particularly preferably actuated by means of a controller which triggers a selectable search run, with the result that the optimum position of the headrest is controlled or adjusted, in particular when getting into the vehicle.

In order to condition the signals, the evaluation electronics and/or the controller preferably have/has signal conditioning and signal processing electronics for a compact and autonomous method of operation of the components.

The controller and/or the evaluation electronics preferably has/have a calibration unit which, when measuring the charge in the signal electrodes and compensation electrodes, takes into account co-determining external parameters such as material, humidity etc. Provision may be made for the calibration unit to carry out calibration when the vehicle is unlocked and it is determined that the vehicle seat is unoccupied. The zero line of the charge or a reference capacitance can then preferably be calibrated since there is no counter-electrode in the form of the head for the signal electrodes on the vehicle seat. In this case, the unlocking of the vehicle relates to the interchange of information for access authorization which can be carried out mechanically, via radio activation or via “keyless-go” or “passive entry”, for example.

Referencing for the capacitors formed from the electrodes is preferably also provided, which referencing takes into account changes in the capacitance or charges on the electrodes on the basis of temperature fluctuations.

The referencing unit may preferably be designed to determine the charge in the electrodes. The charge in the signal electrodes and compensation electrodes is preferably determined when the vehicle is unlocked and it is determined that the vehicle seat is unoccupied.

This makes it possible to take into account the influence of materials in and on the headrest, such as different foams, plastics or various other materials, during calibration without a person being on the vehicle seat.

Further refinements of the invention can be gathered from the following description and the subclaims.

The invention is explained in more detail below using the accompanying diagrammatic illustrations of the exemplary embodiment.

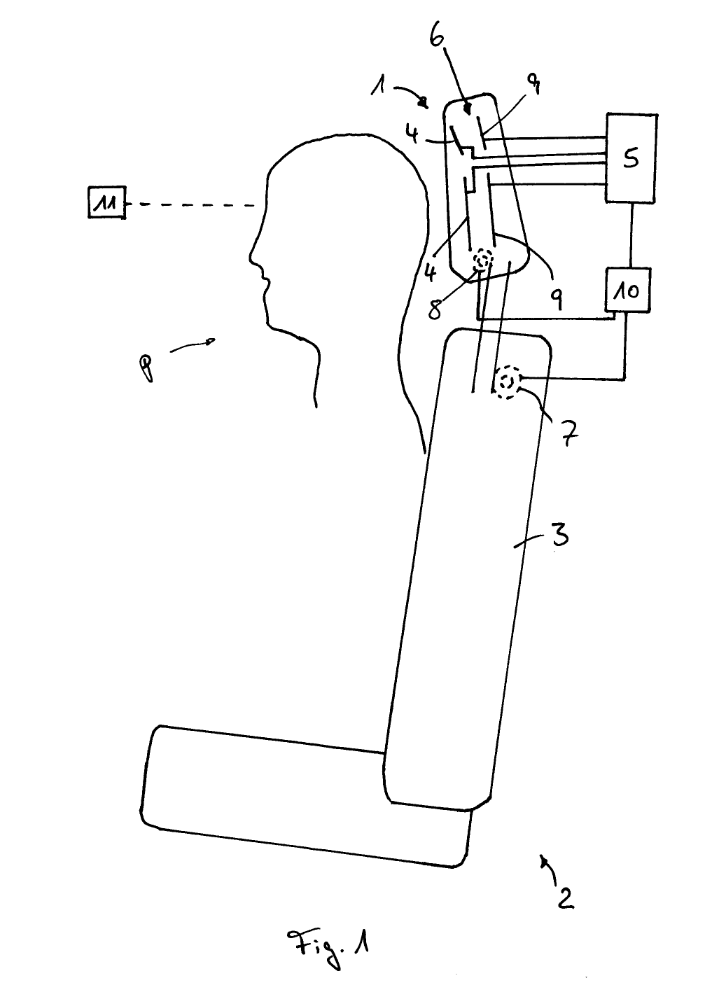

FIG. 1 diagrammatically shows an exemplary embodiment of a headrest with a person sitting on a seat;

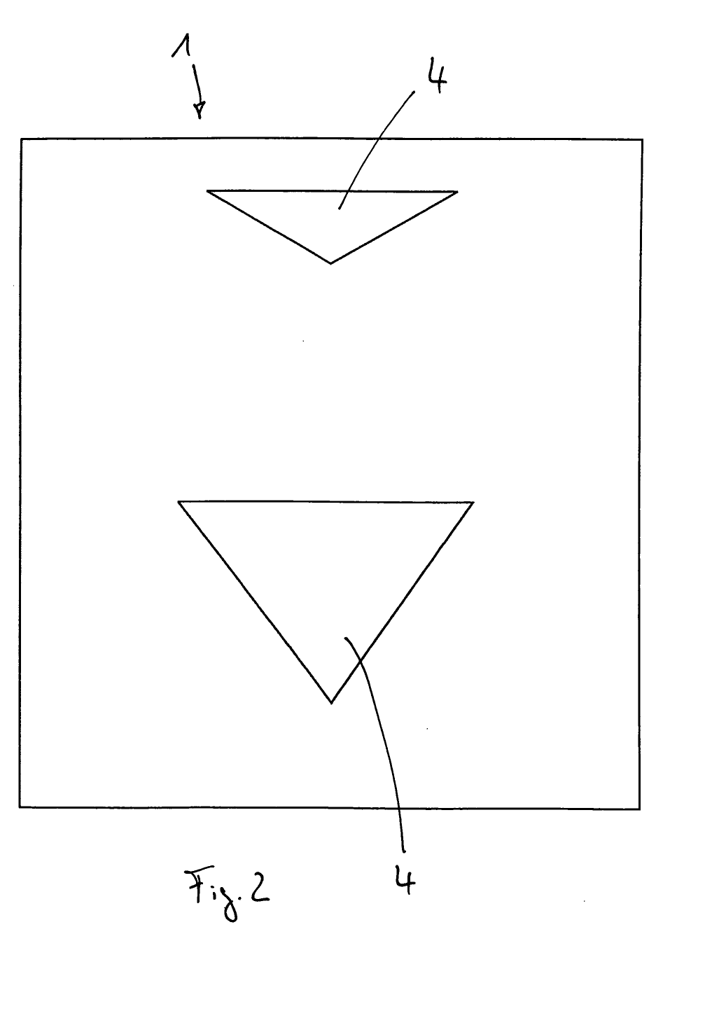

FIG. 2 diagrammatically shows the headrest according to FIG. 1 from the front;

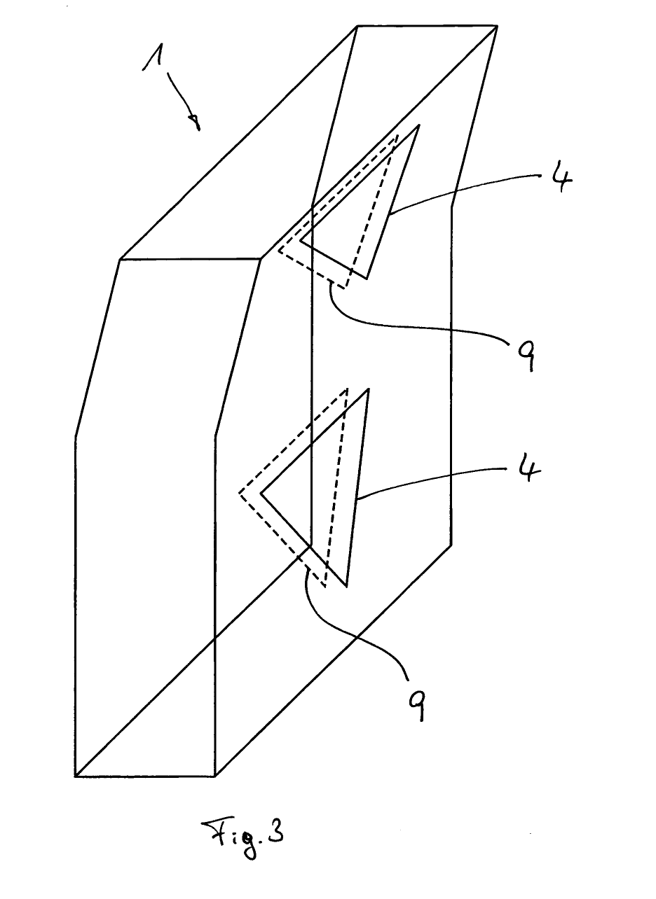

FIG. 3 diagrammatically shows a perspective illustration of the headrest according to FIG. 1 from the front;

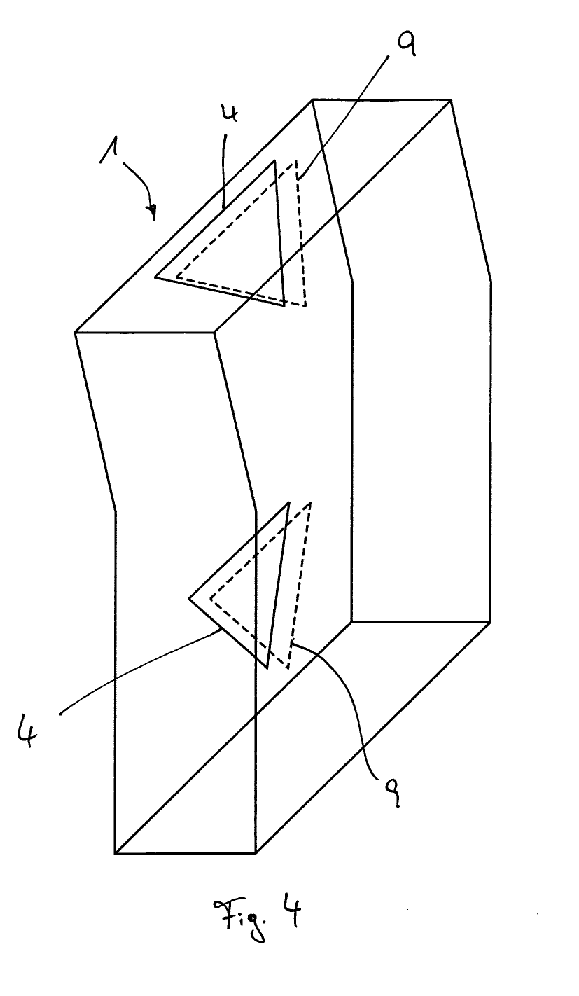

FIG. 4 diagrammatically shows a perspective illustration of the headrest according to FIG. 1 from the back.

FIG. 1 shows a headrest 1 according to the invention which is arranged on a seat 2 above a rest 3, here the backrest. The exemplary embodiment illustrated in FIG. 1 is a headrest 1 for a vehicle seat, for example of a motor vehicle, in which the headrest 1 can be moved relative to the backrest 3 and in relation to the head of a person P sitting on the seat 2. Two signal electrodes 4 for detecting the position of the head of the person P sitting on the seat 2 by producing capacitors each with a counter-electrode formed by the person's P head are provided in the headrest. The two signal electrodes 4 are connected to evaluation electronics 5. The signal electrodes 4 are assigned a compensation device 6 which is connected to the evaluation electronics 5 and, with a rear region of the headrest 1, produces a compensation capacitor device.

In order to move or adjust the headrest 1 in relation to the head of the person P sitting on the seat 2, a drive 7 which can be used to change the height of the headrest 1 in relation to the backrest 3 and the person's P head via guide rods is provided in the backrest 3. A drive 8 which can be used to change the height of the headrest 1 is also provided in the headrest 1, the inclination or distance of the headrest 1 in relation to the person's P head also being able to be adjusted. It is possible to dispense with the drive 7 in the backrest 3 if the drive 8 in the headrest 1 can be used to achieve sufficient travel in terms of height. The drives 7 and 8 may be electrical, pneumatic or hydraulic, and are preferably electrical.

The headrest 1 can be moved from a starting position in order to obtain a measure of the position of the headrest 1 relative to the head using the charges or amounts of charge in the signal electrodes 4 as a result of the production of capacitors with the head as one electrode and one of the signal electrodes 4 as the other electrode of the capacitor. The signal electrodes 4 in the headrest 1 can be used to generate a “virtual fit” for the head of a person P sitting on the seat 2 on the headrest 1. The headrest 1 can be moved until the predefined virtual fit has been optimally applied to the position of the head, that is to say the height and distance with respect to the headrest 1, in particular.

The optimal application of the virtual fit is determined by recording particular predefinable charges or amounts of charge on the signal electrodes 4 which are dependent on the distance and attitude of the head relative to the signal electrodes 4. On the basis of their geometrical dimensions, the signal electrodes 4 form a field pattern which copies a head section, predetermined charges or predefined amounts of charge on the signal electrodes 4 being able to be measured when the headrest 1 has been correctly adjusted. When the headrest 1 has been optimally adjusted in relation to the head, the predefined charge respectively assigned to the signal electrode 4 is measured on all signal electrodes 4. Deviations from the virtual fit, that is to say deviations from the optimum adjustment of the headrest 1, lead to a difference in the charges on the signal electrodes 4 based on the assigned predetermined charge in the signal electrode 4. The adjustment of the headrest 1 should be optimally adapted for different persons P who can sit down on the seat 2. For this purpose, the field pattern is a universal field pattern—an average profile of the back of a human head—of a person P sitting down on the seat 2. The charges in the two signal electrodes 4 thus indicate, as a difference based on the predetermined charge assigned to the signal electrode 4, a measure of the incorrect positioning and/or the adjustment of the headrest 1.

The signal electrodes 4 are electrodes which are shaped toward the head and are oriented toward the head above one another, the upper of the two signal electrodes 4 being inclined toward the lower of the two signal electrodes 4, with the result that the two signal electrodes 4 enclose an angle with one another. The signal electrodes 4 are arranged approximately in the center based on the width of the headrest 1. The signal electrodes 4 are preferably set back in a corresponding manner in comparison with that surface of the headrest 1 which faces the head in order to avoid danger from the head hitting the headrest 1.

In order to determine environmental influences, the compensation device 6 connected to the evaluation electronics 5 determines charges which are induced by the environment essentially from the rear region of the headrest 1 but also from the side region of the headrest. It is thus possible to determine environmental influences which manifest themselves or would manifest themselves in charges or changes in the charge on the signal electrodes 4 which are not caused by the person's P head.

The compensation capacitor device of the headrest 1 shown in FIG. 1 has, for each signal electrode 4, a compensation electrode 9 which is arranged behind the respective signal electrode 4. The compensation electrodes 9 which are arranged behind the signal electrodes 4 in the headrest 1 make it possible to determine changes in the charge which are not caused by the head but by the environment, for instance by metal parts in the headrest 1 or by monitors of a DVD player for back-seat passengers, which monitors are externally fitted to the headrest 1. A higher “resolution” of the changes in the charge caused by the environment is possible by assigning one compensation electrode 9 to each signal electrode 4.

FIG. 2 shows a view of the headrest 1 from the front, the compensation electrodes 9 arranged behind the signal electrodes 4 not being visible since the signal electrodes 4 are the same size as the compensation electrodes 9 and are arranged at the same height as the latter in the exemplary embodiment shown.

FIGS. 3 and 4 illustrate the signal electrodes 4 together with the compensation electrodes 9, the compensation electrodes 9 which are behind the signal electrodes 4 from the point of view of the person P sitting on the seat 2 being illustrated using dashed lines for a clearer illustration. The shape of the signal electrodes 4 is illustrated as triangular without restriction to a specific shape, any shape for forming a field pattern corresponding to the back of a person's P head being possible.

The evaluation electronics 5 determine changes in the charge or charges in the signal electrodes 4 and compensation electrodes 9 by comparing the charges in each signal electrode 4 and compensation electrode 9 with a charge in a reference capacitor. A differential voltage which is used to generate a digital signal can be generated on the basis of the determined difference between the amounts of charge and the charge in the reference capacitor. A digital signal can thus be generated for each of the signal electrodes 4 and compensation electrodes 9; four digital signals in the case illustrated in FIG. 1. The digital signals are evaluated with an algorithm in the evaluation electronics 5, and the evaluation electronics 5 can generate signals which indicate the correct adjustment of the headrest 1 in relation to the person's P head. Taking into account the charges or changes in the charge on the compensation electrodes 9 makes it possible to determine which charges or changes in the charge are caused by the head and which charges or changes in the charge are caused by the rear or side region of the headrest 1.

In the exemplary embodiment shown in FIG. 1, the compensation electrodes 9 have the same shape and size as the signal electrode 4 respectively assigned to them. In this case, like the lower of the compensation electrodes 9, the lower of the two signal electrodes 4 is larger than the upper of the two signal electrodes 4 or compensation electrodes 9.

On attitude of the arrangement of the compensation electrodes 9 and on account of the fact that each signal electrode 4 is assigned a compensation electrode 9, the compensation electrodes 9 can shield the signal electrodes 4 at the rear, that is to say from the region facing away from the head.

The position and distance of the signal electrodes 4 in relation to the compensation electrodes 9 are fixed, with the result that a change in the attitude of the signal electrodes 4 and compensation electrodes 9 relative to one another need not be taken into account by the evaluation electronics 5.

According to one exemplary embodiment, the distance between the headrest 1 and the person's P head can be adjusted independently of the inclination or height in relation to the head. For this purpose, it is possible to change the thickness or spatial extent of the headrest 1 in the direction of the person's P head. In order to change the thickness of the headrest 1, the latter has two outer parts or shells which can be moved relative to one another. It is also possible to move the headrest 1 in a translatory manner relative to the backrest 3 in the direction of the head or away from the latter. Alternatively or additionally, the inclination of the headrest 1 may be adjusted by virtue of the fact that the latter can be pivoted with respect to the backrest 3 via sleeves on the latter, for example.

In order to control the drive 7 and/or the drive 8, provision may be made of a controller 10 which is illustrated in FIG. 1 and is connected to the evaluation electronics 5 and to the drive(s) 7 and/or 8. As an input signal, the controller 10 receives the digital signals which are generated by the evaluation electronics 5 and result from evaluation of the charges on the signal electrodes 4 and the compensation electrodes 9. The controller compares the charges as actual variables with at least one predefinable desired variable of the charges in the signal electrodes 4 for an adjusted end position. The controller 10 may also be provided as part of the evaluation electronics 5 and may thus not be a separate component.

The predefinable desired variable may be assigned to the adjusted end position. In order to reach this adjusted end position, the drives 7 and 8 may be actuated in such a manner that the headrest 1 runs through a selectable search run and the headrest 1 is thus optimally adjusted in relation to the head.

In order to individually adjust the headrest 1 to a person P sitting down on the seat 2, an activation switch generally needs to be operated. Activation changes the height of the headrest 1 and/or moves the latter forward or backward and/or changes the inclination of the headrest until the particular predefined charges or amounts of charge on the signal electrodes 4 are recorded taking into account the charges or amounts of charge in the compensation electrodes 9. The process of automatically adjusting the height and distance of the headrest 1 relative to the person's P head can be carried out iteratively.

In addition or as an alternative to automatically adjusting the headrest 1 by means of one or both of the drives 7, 8, provision may be made for the position of the headrest 1 in relation to the head of the person P sitting on the vehicle seat to be displayed on a display 11. For this purpose, the display 11 is connected to the evaluation electronics 5. The height and distance of the position of the head can be displayed separately on the display 11. The display 11 displays that there is incorrect positioning until the correct height and the correct distance have been set.

According to the exemplary embodiment shown in FIG. 1, the evaluation electronics 5 and/or the controller 10 have/has signal conditioning and signal processing electronics.

For calibration and referencing, a calibration and referencing unit may be provided in the evaluation electronics 5 and/or the controller 10. The referencing unit may comprise a capacitor which can be used to set a preset capacitance or reference charge. The preset capacitance can be used to determine the charges at or on the signal electrodes 4 and compensation electrodes 9 by comparison with the reference charge. If necessary, the referencing unit may record the magnitude of the reference charge and use it for evaluation in the evaluation electronics 5 or controller 10. Each of the signal electrodes 4 and compensation electrodes 9 can be referenced in this manner via an apparatus for referencing and thus referring to a predetermined value, with the result that the same reference variable can be selected for all signal electrodes 4 and compensation electrodes 9.

For calibration, the calibration unit may be designed to determine the charge in the signal electrodes 4 and the compensation electrodes 9 in order to record the charges on the signal electrodes 4 and compensation electrodes 9 when unlocking the vehicle.

1. A headrest (1) for a seat (2), in particular a vehicle seat, having at least two signal electrodes (4) for detecting the position of a head of a person (P) sitting on the vehicle seat by producing capacitors each with a counter-electrode formed by the person's (P) head, and the at least two signal electrodes (4) are connected to evaluation electronics (5), wherein the improvement comprises that the signal electrodes (4) are assigned a compensation device (6) which is connected to the evaluation electronics (5) and, with a rear region of the headrest (1), produces a compensation capacitor device.

2. The headrest (1) as claimed in claim 1, wherein each signal electrode (4) is operatively associated with one compensation electrode (9) of the compensation device (6) in order to form a respective compensation capacitor device.

3. The headrest (1) as claimed in claim 2, wherein the compensation electrodes (9) have the same size and shape as the signal electrodes (4) associated with them.

4. The headrest (1) as claimed in claim 2, wherein the compensation electrodes (9) are arranged in such a manner that they shield the signal electrodes (4) from the region facing away from the head.

5. The headrest (1) as claimed in claim 2, wherein the distance between and the attitude of the signal electrodes (4) and of the compensation electrodes (9) are fixed.

6. The headrest (1) as claimed in claim 2, wherein the headrest (1) has two outer parts which can be moved relative to one another and can be used to change the thickness of the headrest (1) in the direction of the head of the person (P) sitting on the vehicle seat.

7. The headrest (1) as claimed in claim 1, wherein the evaluation electronics (5) are connected to a display (11) for displaying the position of the headrest (1) in relation to the head.

8. The headrest (1) as claimed in claim 1, wherein the evaluation electronics (5) are connected to a controller for controlling at least one drive (7, 8) in order to reach an adjusted end position of the headrest (1).

9. The headrest (1) as claimed in claim 1, wherein the at least two signal electrodes (4), when combined, are designed to form a field pattern which copies a head section.

10. The headrest (1) as claimed in claim 2, wherein a controller (10) is provided for at least one drive (7, 8), which controller compares the charges in the signal electrodes (4) and compensation electrodes (9), recorded by the evaluation electronics (5), as actual variables with at least one respective predefinable desired variable of the charges for an adjusted end position.

11. The headrest (1) as claimed in claim 10, wherein the at least one drive (7, 8) can be actuated by means of a controller (10) which triggers a selectable search run of the headrest (1).

12. The headrest (1) as claimed in claim 10 wherein the evaluation electronics (5) and/or controller (10) have/has signal conditioning and signal processing electronics.

13. The headrest (1) as claimed in claim 10, wherein the evaluation electronics (5) and/or the controller (10) have/has a calibration unit and/or a referencing unit.

14. The headrest (1) as claimed in claim 13, wherein the referencing unit can be used to record at least one reference charge if required.

15. The headrest (1) as claimed in claim 13 wherein an apparatus for referencing the respective signal electrodes (4) and compensation electrodes (9) is provided.

16. The headrest (1) as claimed in claim 13, wherein the headrest (1) is provided for a vehicle seat, and the calibration unit is designed to determine the charge in one of the signal electrodes (4) and compensation electrodes (9) if unlocking of the vehicle is detected.

17. The headrest as claimed in claim 1, wherein the evaluation electronics (5) are connected to a seat occupancy detection apparatus in order to provide the seat occupancy detection apparatus with a signal regarding seat occupancy of the seat (2).

18. The headrest as claimed in claim 1, wherein the seat (2) is a vehicle seat, and the evaluation electronics (5) are connected to a drive unit for motors of an electrically adjustable outside mirror in order to provide signals regarding optimum adjustment of the outside mirror to the position of the head.

19. A headrest (1) for a seat (2), having a front facing the head of a person to be seated and a rear facing away from the head of a person to be seated, said headrest comprising:
at least two signal electrodes (4) toward the front of the headrest each of which carries a measurable electrical charge that is influenced by the characteristics of a person's head when the head is positioned in proximity to the signal electrodes;
an evaluation circuit connected to the at least two signal electrodes for determining the position of the head relative to the headrest by processing the measured charges; and
a signal compensation device (6) having electric field sensors situated toward the rear of the headrest behind the signal electrodes and connected to the evaluation circuit (5), responsive to electric fields in a rear region of the headrest facing away from the head (1), and producing a compensation applied to the determination of the position of the person's head.

20. The headrest as claimed in claim 19, wherein:
each signal electrode is a charged plate that establishes a capacitive relationship with the person's head as a counter-electrode when the person's head is in proximity to the front of the headrest;
each electric field sensor of the signal compensating device is a compensation electrode in the form of a charged plate and each signal electrode is operatively associated with a respective compensation electrode;
wherein each signal electrode is shielded by its respective compensation electrode from electric fields in said rear region of the headrest.
